(19) United States
(12) Patent Application Publication
(10) Pub. No.: US 2017/0064983 A1
(43) Pub. Date: Mar. 9, 2017

(54) JUICE BLENDS AND METHOD OF PRODUCING

(71) Applicants: MICHELLE NAZAROFF, North Vancouver (CA); Kevin Friesen, North Vancouver (CA)

(72) Inventors: MICHELLE NAZAROFF, North Vancouver (CA); Kevin Friesen, North Vancouver (CA)

(21) Appl. No.: 15/081,008

(22) Filed: Mar. 25, 2016

Related U.S. Application Data
(60) Provisional application No. 62/213,844, filed on Sep. 3, 2015.

(51) Int. Cl. A23L 2/02; A23L 2/66; A23L 2/60; A23L 2/52

(52) U.S. Cl. CPC A23L 2/02; A23L 2/52; A23L 2/66; A23L 2/60; A23V 2002/00

(57) ABSTRACT

A method of producing a beverage can include combining a first quantity of juice with a second quantity of protein to form a mixture. The method can also include adding a third quantity of fatty acid to the mixture to produce a beverage. The method can also include cold pressing, prior to the combining, a fourth quantity of at least one of fruit matter and vegetable matter to obtain the first quantity of juice.

### CROSS-REFERENCE TO RELATED APPLICATIONS

This application claims the benefit of U.S. Provisional Patent Application Ser. No. 62213844 for CONSUMABLE PRODUCTS, filed on 2015 Sep. 30, which is hereby incorporated by reference in its entirety.

### BACKGROUND

1. Field

The present disclosure relates to products and compositions in any physical form which are intended to be consumed by human beings in whole or part via the oral cavity and more particularly to beverages intended to be drunk wherein the beverage includes the juice from a fruit or vegetable source.

2. Description of Related Prior Art

U.S. Pat. No. 6,811,804 discloses JUICE AND SOY PROTEIN BEVERAGE AND USES THEREOF. The beverage relates generally to a thin texture, ready-to-drink, shelf-stable refreshing juice/soy beverage. Other aspects of disclosure of the '804 patent relate to methods of providing phytochemicals from soy, fruit and vegetable juices to a health conscious population.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method of producing a beverage can include combining a first quantity of juice with a second quantity of protein to form a mixture. The method can also include adding a third quantity of fatty acid to the mixture to produce a beverage. The method can also include cold pressing, prior to the combining, a fourth quantity of at least one of fruit matter and vegetable matter to obtain the first quantity of juice.

### DETAILED DESCRIPTION

The present disclosure, as demonstrated by the exemplary embodiments described below, can provide cold pressed fruit and vegetable juice with no added synthetic ingredients or fillers blended with protein and essential fatty acids to create a whole balanced meal for consumption for all ages of humans. It is noted that sprouts are a form of vegetable. The process of blending protein, in powder, paste, or liquid form and derived from all possible vegan protein sources, and essential fatty acids from whole food bases into cold pressed fruit, vegetable and sprout juice creates a whole food balanced meal for all ages as it covers all the macro nutrients the body requires in one sitting to deliver all key nutrients required by the body to function optimally. Embodiments of the present disclosure can replace a conventional meal.

The protein juice of the present disclosure creates satiety and regenerates the body from within, while feeding the trillions of cells that are turning over in the human body daily. The digestive process is bypassed as the liquid nature of the protein juice is already pre-digested thus taking the load off the body and allowing it to repair and regenerate. This defines anti-aging functionality.

Embodiments of this disclosure can deliver real food, really fast. It's the new age fast food that can actually regenerate and protect the human body. The protein juice is a balanced meal in a liquid form that is tasty, calorie controlled and balanced and provides the human body the vitamins, minerals, enzymes and phytonutrients it requires to preserve life and prevent disease. All ingredients in the protein juice are from whole foods and no synthetic ingredients are added as the body is designed to take in nutrients from whole real food as opposed to man-made synthetic ingredients.

A method of producing a beverage can include cold pressing a quantity of at least one of fruit matter and vegetable matter to obtain the first quantity of juice. A single type of fruit matter or vegetable matter can be utilized. Alternatively, a combination of fruit matter and vegetable matter, different forms of fruit matter, or different forms of vegetable matter can be utilized.

Cold pressing the fruit and/or vegetable matter provides numerous advantages to embodiments of the present disclosure. The matter is subjected to less heat during the juicing process, compared to traditional blenders in which a blade is used. The heat oxidizes nutrients, rendering less nutritious juice than a juice that has been produced by cold pressing. Cold pressing also allows the inclusion of leafy greens. Cold pressing can also be utilized to extract liquid from nuts. Nut milks and green juices can be utilized by the body to cleanse and detoxify itself.

Cold pressing also allows the juice to remain more flavorful. The inventor has found that juice derived from cold pressing tastes better than juice produced by a bladed-juicer. Further, the improved taste is retained over the shelf-life of the product. Enhanced flavor will incentivize the consumption of healthier products, such as juices according to the present disclosure.

Embodiments of the present disclosure provide enhanced nutrients since spinning blades of traditional centrifugal juicers expose fruit and vegetables to heat and oxygen, both of which degrade nutrients. Embodiments of the present disclosure can be withheld from pasteurization which also involves heat and further denatures critical nutrients. Because air is not forced into the juice during extraction, cold press juice will keep for 3 to 5 days without oxidising or losing nutritional integrity. Thus embodiments of the present disclosure uses cold pressing techniques to create the base fruit and vegetable juice and this base juice will furnish all the cells and tissues of the body with the elements and nutritional enzymes they need in the manner that can be most readily digested and assimilated. Embodiments of the present disclosure can define 100% wholefoods based ready to drink protein fortified cold pressed juice.

Most vitamins and minerals and phytonutrients are destroyed or damaged when heated above 130° F. and are thus less available for assimilation. In short, a pasteurised juice or juice from concentrate defines “empty” foods or empty calories that just fill one up temporarily. The drinker will end up not feeling satiated because there are not enough bio-available nutrients which are needed by the body. Drinking cold pressed fruit, vegetable, nut, seeds, sprouts will increase the micronutrients in the diet substantially and body fat will decrease, cravings will subside and the cells will be revitalised.

Cold press protein juice deliver huge amounts of enzymes which are the power of life. They are the living forces that conduct and direct every activity in the body. Enzymes help repair DNA & RNA. One of the keys for easy weight/fat loss is through the action of enzymes. Lipase a splitting enzyme found in raw fruit and vegetables. Lipase helps the body in digestion and fat burning for energy. Protease is another enzyme for keeping a healthy body. Protease split up proteins into their component amino acid building blocks and help eliminate toxins. Enzymes are extremely heat sensitive and destroyed at temps above 188° F. Pasteurization destroys nutrients and enzymes. In embodiments of the present disclosure, the phyto nutrients, vitamins, minerals and enzymes are all intact and create an amazing vehicle to deliver important proteins and essential fatty acids to the body in an easy assimilated way.

Proteins can be blended through the cold pressed fruit and vegetable juice at low speed to ensure no heat is generated. Protein is damaged by heat and heating causes the amino acids to congeal. Damaged protein is for the most part unusable and can be harmful to your body, such as by causing inflammation. Amino acids, the building blocks of protein begin to deteriorate at temps over 118° F. and completely destroyed at 160° F.

Vegetables, fruit, nuts, seeds, algae, sprouts and leafy greens contain up to 50% of their calories from protein in their raw state so the combination of cold pressed fruit and vegetable juice and raw, natural protein is very powerful for the body.

More protein is assimilated in raw cold pressed juice than in pasteurized juice or from concentrate. Therefore it's not the quantity but the quality that's important and the point of difference between embodiments of the present disclosure and other juices. Embodiments of the present disclosure allows the body to assimilate the nutrients and protein (amino acids) much more efficiently because they are not destroyed or degenerated by heat.

Raw fats can be blended into embodiments of the present disclosure to deliver mono unsaturated fats and poly unsaturated fats using whole food based avocados, sprouted raw nuts and seeds which can bind with toxins, helping to eliminate them from the body. Essential fatty acids protect the cell membranes and are crucial for hormonal health. Again, the essential fatty acids are not heated and are blended into the cold pressed fruit and vegetable base at slow speed to create a creamy emulsion and binds all the ingredients together to make a stable juice which is easily assimilated and digested by the body.

The method can also include combining the quantity of juice with a quantity of protein to form a mixture. The quantity of protein can be in powder form, liquid form, or paste form. The protein can be a vegan protein. An example of vegan and powder protein is Sun Warrior Plant Protein Powder sold by Sun Warrior (https://www.sunwarrior.com/). Another type of protein that can be utilized is Ultimate Protein sold by Nutri-Dyn, which a whey based protein. Other sources of protein can be utilized as well. Such sources include, but are not limited to, seaweed/spirulina, cannelloni beans, hemp seeds, wheatgrass, fermented brown rice, and peas.

The method can also include adding a quantity of fatty acid to the mixture to produce a beverage. The quantity of fatty acid can be obtained by adding an avocado to the mixture. The quantity of fatty acid can be obtained by adding nut milk or nut paste to the mixture. The quantity of fatty acid can be obtained by adding chia seed to the mixture. The quantity of fatty acid can be obtained by adding coconut to the mixture.

The quantities of the various components of embodiments of the present disclosure can be selected such that the beverage includes at least twenty grams of protein per five hundred milliliters of beverage. The quantities of the various components of embodiments of the present disclosure can be selected such that the beverage includes at least ten grams of fatty acids per five hundred milliliters of beverage. The quantities of the various components of embodiments of the present disclosure can be selected such that the beverage includes at least twenty grams of carbohydrates per five hundred milliliters of beverage.

Other materials can be added to one or more embodiments of the present disclosure. In one or more embodiments, coconut water can be incorporated to the beverage. Sweeteners can be incorporated. Cacao can also be incorporated. Materials can be incorporated to enhance taste without compromising nutritional value.

### EXAMPLE 1

In a first example, a mixture of beet (approximately one-half of a two inch diameter beet), ginger (one-half tsp), apple (one large, approximately three and one quarter inch diameter), a lemon and a lime can be pressed together to produce juice. It is expected that the produced juice will include 250 mls of apple juice, 75 mls beetroot juice, 25 mls ginger juice, 10 mls lime juice, 25 mls lemon juice. The mixture can then be blended with one serving Bulk Nutrients Plant Protein Powder (1.1 scoop of organic biofermented brown rice protein powder) or Bulk Nutrients Whey Protein Isolate protein powder and 2 ounces of fresh raw avocado and ¼ of a serve of Anutra Micro Fine Chia Flour. The avocado and chia flour provides fatty acids and fibre to the mixture. Stevia Liquid (natural sweetener, 5 drops) can also be added to the blend and 1 drop of lemon essential oil. The resulting beverage is one serving having 359 kCal, 10.3 g of fat, 35.2 g of carbohydrates, 28.8 g of protein, 2.5 g of saturated fat, 0 g of cholesterol, 6 g of fiber, and 116 mg of sodium.

### EXAMPLE 2

In a second example, a mixture of apple 145 mls,) and mint (15 mls) can be pressed together to form juice. 10 milliliters of cold pressed lime juice can be added, 45 mls of spinach juice, 50 mls of swiss chard juice and 20 mls of pineapple juice can be added. The juice mixture can then be blended with 1.1 serves of Bulk Nutrients Plant Protein Powder (1.1 scoop of organic biofermented brown rice protein powder) or 1 serve Bulk Nutrients Whey Protein Isolate protein powder), and 2 oz of fresh avocado and ¼ serve of Anutra Micro Fine chia flour The avocado and chia flour provides fatty acids to the mixture. 50 mls of water will be added. Stevia Liquid (natural sweetener, 5 drops) can also be added to the blend. The resulting beverage is one serving having 354 kCal, 10.5 g of fat, 33.5 g of carbohydrates, 28 g of protein, 2.5 g of saturated fat, 0 g of cholesterol, 6 g of fiber, and 202 mg of sodium.

### EXAMPLE 3

In a third example, a mixture of lime, apple, and pineapple can be pressed together to form juice. The cold pressing can result in 15 ml of lime juice, 75 ml of apple juice, and 125 mls of pineapple juice. The juice can then be blended with 1.1 serving Ultimate Protein, coconut water (200 ml), and 2 oz of fresh avocado. 1.5 drops of lime essential oil can be added to the mix. One ounce of equal parts nuts (such as almonds) and coconut flesh can also be pressed to form liquid containing fatty acids, which can be added to the mixture. The resulting beverage is one serving having 389 kCal, 10 g of fat, 48 g of carbohydrates, 30 g of protein, 2 g of saturated fat, 0 g of cholesterol, 6 g of fiber, and 53 mg of sodium.

### EXAMPLE 4

In a fourth example, 130 ml of cold pressed orange juice can be combined with one serving Bulk Nutrients Plant Protein Powder (1.1 scoop of organic biofermented brown rice protein powder) or Bulk Nutrients Whey Protein Isolate protein powder 250 mls of cold pressed nut milk (such as almonds) can also be pressed to form liquid containing fatty acids, which can be added to the mixture. 2 ounces of fresh raw avocado and ¼ of a serve of Anutra Micro Fine Chia Flour) and 1.5 oz of fresh banana can be blended with the mixture. 25 mls of water will be added to the mixture and 0.5 oz of cacao can also be added to the blend. The resulting beverage is one serving having 340 kCal, 10.4 g of fat, 31.8 g of carbohydrates, 28.1 g of protein, 1.4 g of saturated fat, 0 g of cholesterol, 10 g of fiber, and 44 mg of sodium.

It is noted that servings of the various juice embodiments can be made in child portions by reducing by half (50%) the quantities of ingredients. The various juice mixtures can be frozen in molds to form treats for children; 250 mls of an embodiment of the juice was satisfactorily used. Also, alcohol can be included in one more embodiments without detracting from the beneficial health values. An embodiment of the protein juice can be infused with coffee or a tea blend. Finally, high pressure pasteurization can be utilized in one or more embodiments of the present disclosure.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A method of producing a beverage comprising:
combining a first quantity of juice with a second quantity of protein to form a mixture;
adding a third quantity of fatty acid to the mixture to produce a beverage; and
cold pressing, prior to said combining, a fourth quantity of at least one of fruit matter and vegetable matter to obtain the first quantity of juice.

2. The method of claim 1 wherein said cold pressing is further defined as:
cold pressing, prior to said combining, the fourth quantity of fruit including beet, ginger, apple, and lime to obtain the first quantity of juice.

3. The method of claim 1 wherein said cold pressing is further defined as:
cold pressing, prior to said combining, the fourth quantity of fruit including apple, lime, cucumber, and mint to obtain the first quantity of juice.

4. The method of claim 1 wherein said cold pressing is further defined as:
cold pressing, prior to said combining, the fourth quantity of fruit including apple, lime, and pineapple to obtain the first quantity of juice.

5. The method of claim 1 wherein said cold pressing is further defined as:
cold pressing, prior to said combining, the fourth quantity of fruit including orange to obtain the first quantity of juice.

6. The method of claim 1 wherein said combining is further defined as:
combining the first quantity of juice with the second quantity of protein consisting of power to form the mixture.

7. The method of claim 1 wherein said combining is further defined as:
combining the first quantity of juice with the second quantity of vegan protein to form the mixture.

8. The method of claim 1 further comprising:
selecting the protein from the group consisting of cannelloni beans, hemp seeds, spirulina, wheatgrass, fermented brown rice, peas, and whey.

9. The method of claim 1 wherein said adding is further defined as:
adding the third quantity of fatty acid from an avocado to the mixture.

10. The method of claim 1 wherein said adding is further defined as:
adding the third quantity of fatty acid from a nut to the mixture.

11. The method of claim 1 wherein said adding is further defined as:
adding the third quantity of fatty acid from chia seed to the mixture.

12. The method of claim 1 wherein said adding is further defined as:
adding the third quantity of fatty acid from coconut to the mixture.

13. The method of claim 1 further comprising:
selecting the second quantity such that the beverage includes at least twenty grams of protein per five hundred milliliters of beverage.

14. The method of claim 1 further comprising:
selecting the third quantity such that the beverage includes at least ten grams of fatty acids per five hundred milliliters of beverage.

15. The method of claim 1 further comprising:
selecting the first, second and third quantities such that the beverage includes at least twenty grams of carbohydrates per five hundred milliliters of beverage.

16. The method of claim 1 further comprising:
incorporating a coconut water to the beverage.

17. The method of claim 1 wherein:
said cold pressing is further defined as cold pressing, prior to said combining, the fourth quantity of fruit including beet, ginger, apple, and lime to obtain the first quantity of juice;
said combining is further defined as combining the first quantity of juice with the second quantity of protein consisting of vegan power to form the mixture;
said adding is further defined as adding the third quantity of fatty acid from an avocado to the mixture; and
further comprising incorporating a sweetener and oil to the beverage.

18. The method of claim 1 wherein:
said cold pressing is further defined as cold pressing, prior to said combining, the fourth quantity of fruit including apple, lime, cucumber, and mint to obtain the first quantity of juice;
said combining is further defined as combining the first quantity of juice with the second quantity of vegan protein consisting of powder to form the mixture; and
said adding is further defined as adding the third quantity of fatty acid from an avocado to the mixture and said adding is further defined as adding a third quantity of oil to the mixture

19. The method of claim 1 wherein:
said cold pressing is further defined as cold pressing, prior to said combining, the fourth quantity of fruit including apple, lime, and pineapple to obtain the first quantity of juice;
said combining is further defined as combining the first quantity of juice with the second quantity of vegan protein consisting of powder to form the mixture;
said adding is further defined as adding the third quantity of fatty acid from a nut to the mixture; and
further comprising incorporating a coconut water to the beverage and oil.

20. The method of claim 1 wherein:
said cold pressing is further defined as cold pressing, prior to said combining, the fourth quantity of fruit including orange to obtain the first quantity of juice;
said combining is further defined as combining the first quantity of juice with the second quantity of vegan protein consisting of powder to form the mixture;
said adding is further defined as adding the third quantity of fatty acid from chia seed to the mixture; and
further comprising incorporating cacao to the beverage.
